(19) United States
(12) Patent Application Publication
(10) Pub. No.: US 2023/0342655 A1
(43) Pub. Date: Oct. 26, 2023

(54) Semi-Supervised Vertical Federated Learning

(71) Applicants: INTERNATIONAL BUSINESS MACHINES CORPORATION, ARMONK, NY (US); Rensselaer Polytechnic Institute, Troy, NY (US)

(72) Inventors: Timothy John Castiglia, Troy, NY (US); Shiqiang Wang, White Plains, NY (US); Stacy Elizabeth Patterson, Troy, NY (US)

(21) Appl. No.: 17/660,699

(22) Filed: Apr. 26, 2022

(51) Int. Cl. G06N 20/00; H04L 41/14

(52) U.S. Cl. CPC G06N 20/00; H04L 41/145

(57) ABSTRACT

A Vertical Federated Learning system with multiple parties and a server where feature space is partitioned across multiple parties, and training includes unsupervised representation learning at each party alone followed by coordinated training with all parties and the server. Parties train representation networks on unlabeled data without communicating with other parties, then send representations of their labeled feature sets to the server, and the server trains a prediction model on labeled data without further communication with parties. Parties train representation networks on unlabeled data without communicating with other parties, then the parties and server collaboratively train the representation networks and a prediction model on labeled data. Parties alternate between training their representation networks on unlabeled data without communication and sending their representations of labeled data to the server for training a prediction model.

### BACKGROUND

The present invention relates generally to the field of machine learning (ML), and more particularly to semi-supervised vertical federated learning.

The Wikipedia entry for “federated learning” (as of 6 Apr. 2022) states, in part, as follows: “Federated learning (also known as collaborative learning) is a machine learning technique that trains an algorithm across multiple decentralized edge devices or servers holding local data samples, without exchanging them. This approach stands in contrast to traditional centralized machine learning techniques where all the local datasets are uploaded to one server, as well as to more classical decentralized approaches which often assume that local data samples are identically distributed. Federated learning enables multiple actors to build a common, robust machine learning model without sharing data, thus allowing to address critical issues such as data privacy, data security, data access rights and access to heterogeneous data.”

The Wikipedia entry for “semi-supervised learning” (as of 6 Apr. 2022) states, in part, as follows: “Semi-supervised learning is an approach to machine learning that combines a small amount of labeled data with a large amount of unlabeled data during training. Semi-supervised learning falls between unsupervised learning (with no labeled training data) and supervised learning (with only labeled training data). It is a special instance of weak supervision. Unlabeled data, when used in conjunction with a small amount of labeled data, can produce considerable improvement in learning accuracy. The acquisition of labeled data for a learning problem often requires a skilled human agent (e.g., to transcribe an audio segment) or a physical experiment (e.g., determining the 3D structure of a protein or determining whether there is oil at a particular location). The cost associated with the labeling process thus may render large, fully labeled training sets infeasible, whereas acquisition of unlabeled data is relatively inexpensive.”

Federated learning is a category of distributed ML setting that typically includes a set of clients and a server collaboratively training a model on client-owned data. Client data may be partitioned by their features. For example, a bank and hospital may have data pertaining to the same individuals, with the bank having financial data and the hospital having medical information. Vertical Federated Learning (VFL) is a method of training on such vertically-partitioned data. However, most VFL approaches depend on labeled data for training, and it is often the case that data is unlabeled for a desired learning task. Labeling data can be an expensive task, and there may only be a small amount of labeled data that does not fully capture the underlying data distribution. Under a standard VFL currently conventional, clients compute representations on labeled data for a mini-batch and send to the server. The server makes a prediction with the given representations. The server then updates its prediction model and sends the gradients to the clients. The clients use the gradients to update their own representation models. This process is repeated until training is complete.

Some ML uses “models” that create “representations.” A representation, as that term is used herein is the output of an ML model (sometimes herein more simply referred to as an ML model) for a given input. Representations should not be confused with labels. A representation is not a classification result. Typically, a representation is organized and expressed as a vector that captures useful inherent characteristics of the input data to the model. The model is trained by unsupervised learning and/or supervised learning. A given model usually remains fixed after it is trained. A model does not change with the input data during an inference phase, whereas the representation does change in response to input data that is received and processed by the model when computing the representation.

The Wikipedia entry for “feature learning” (as of 11 Apr. 2022) states, in part, as follows: “In machine learning, feature learning or representation learning is a set of techniques that allows a system to automatically discover the representations needed for feature detection or classification from raw data. This replaces manual feature engineering and allows a machine to both learn the features and use them to perform a specific task. Feature learning is motivated by the fact that machine learning tasks such as classification often require input that is mathematically and computationally convenient to process. However, real-world data such as images, video, and sensor data has not yielded to attempts to algorithmically define specific features. An alternative is to discover such features or representations through examination, without relying on explicit algorithms. Feature learning can be either supervised or unsupervised. In supervised feature learning, features are learned using labeled input data. Examples include supervised neural networks, multilayer perceptron and (supervised) dictionary learning. In unsupervised feature learning, features are learned with unlabeled input data. Examples include dictionary learning, independent component analysis, autoencoders, matrix factorization and various forms of clustering.” (footnotes omitted)

### SUMMARY

According to an aspect of the present invention, there is a method, computer program product and/or system for use with a federated computer system that includes a server subsystem and a plurality of client subsystems, with each client sub-system including stored unlabeled data, with the server subsystem being in communication with each client subsystem through a communication network, and with each client subsystem not being permitted access to stored unlabeled data of other client subsystems of the federated computer system that performs the following operations (not necessarily in the following order): (i) receiving, by the server subsystem, an untrained server-side machine learning (ML) model; (ii) receiving, from each given client subsystem, over the communication network and by the server subsystem, a respective collection of representations that have been obtained at the given client subsystem through models located at the given client subsystem and trained on the unlabeled data of the given client subsystem using unsupervised learning; (iii) aggregating, by the server subsystem, the representations of the collections of representations respectively received from each client subsystem of the plurality of client subsystems to obtain an input to the untrained server-side machine learning (ML) model; and (iv) inputting the input to the untrained server-side ML model to train the untrained server-side ML model using supervised learning to thereby obtain a trained server-side ML model that can recognize a plurality of patterns when the trained server-side ML model receives new representations from the plurality of client subsystems.

### BRIEF DESCRIPTION OF THE DRAWINGS

FIG. 1 is a block diagram of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a block diagram that shows an example of a vertical federated learning model architecture;

FIG. 5 is a screenshot showing an algorithm according to the present invention; and

FIG. 6 is a screenshot showing another algorithm according to the present invention.

### DETAILED DESCRIPTION

Some embodiments of the present invention are directed to Vertical Federated Learning system with multiple parties and a server where feature space is partitioned across multiple parties, and training includes unsupervised representation learning at each party alone followed by coordinated training with all parties and the server. In some embodiments, parties train representation networks on unlabeled data without communicating with other parties, then send representations of their labeled feature sets to the server, and the server trains a prediction model on labeled data without further communication with parties. In some embodiments, parties train representation networks on unlabeled data without communicating with other parties, then the parties and server collaboratively train the representation networks and a prediction model on labeled data. In some embodiments, parties alternate between training their representation networks on unlabeled data without communication and sending their representations of labeled data to the server for training a prediction model. In some embodiments, parties alternate between training their representation networks on unlabeled data without communication and training the representation networks and prediction model on labeled data collaboratively with multiple parties and the server.

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

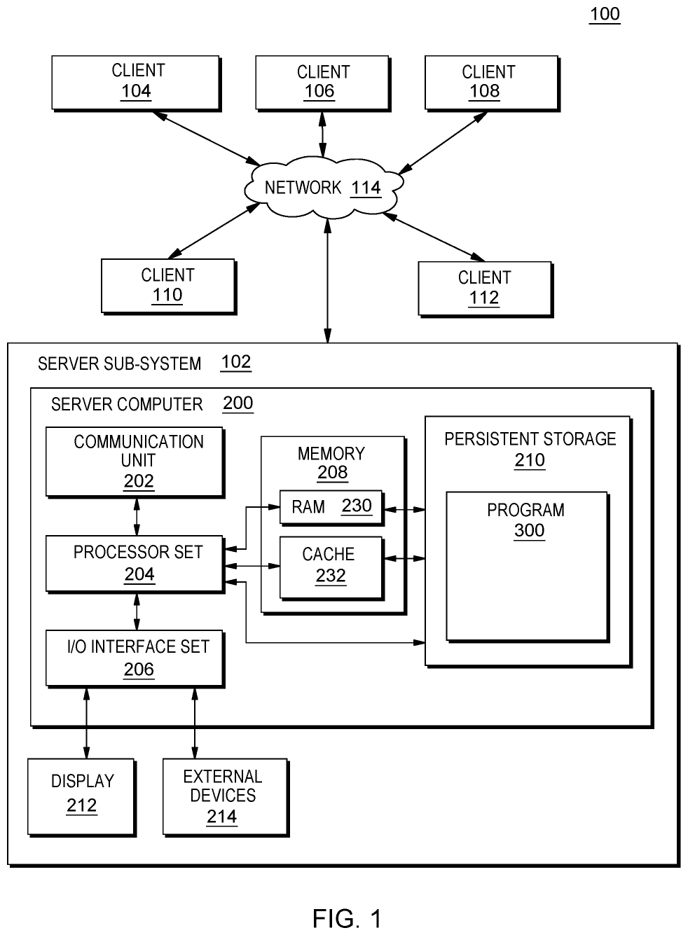

As shown in FIG. 1, federated computer system 100 is an embodiment of a hardware and software environment for use with various embodiments of the present invention. Networked computers system 100 (sometimes herein referred to as “federated computer system”) includes: server subsystem 102 (sometimes herein referred to, more simply, as subsystem 102); client subsystems 104, 106, 108, 110, 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

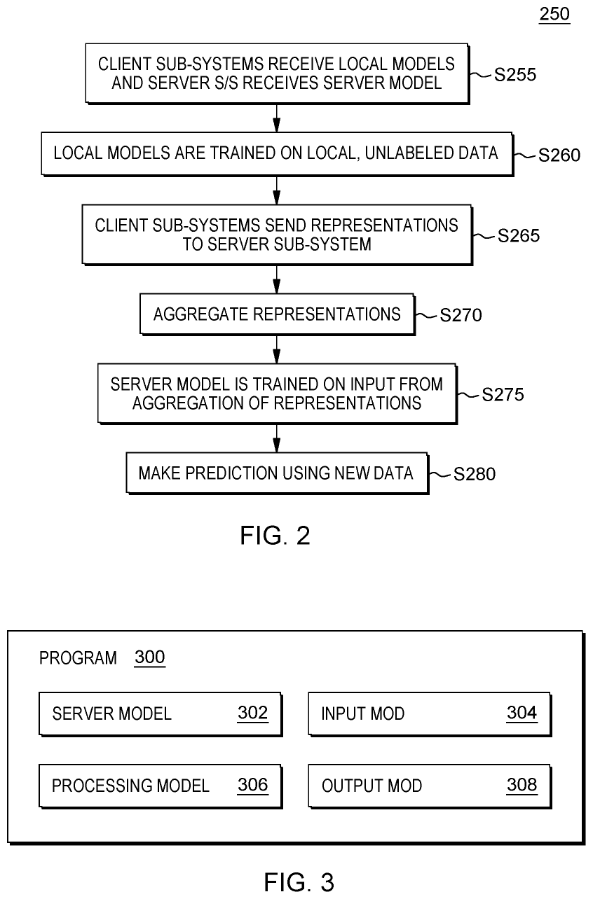

As shown in FIG. 1, networked computers system 100 is an environment in which an example method according to the present invention can be performed. As shown in FIG. 2, flowchart 250 shows an example method according to the present invention. As shown in FIG. 3, program 300 performs or control performance of at least some of the method operations of flowchart 250. This method and associated software will now be discussed, over the course of the following paragraphs, with extensive reference to the blocks of FIGS. 1, 2 and 3. The method of flowchart 250 is used with federated computer system 100 (including server subsystem 102 and a plurality of client subsystems 104, 106, 108, 110 and 112). Each client sub-system includes stored unlabeled data (not separately shown in FIG. 1). Because system 100 is a federated computer system each of the client subsystems not is not permitted access to stored unlabeled data of other client subsystems of the federated computer system. In this embodiment, and as is true in some federated computer systems, server subsystem 102 is also denied direct access to the stored unlabeled data on each of the client subsystems.

Processing begins at operation S255, where: (i) client subsystems 104, 106, 108, 110, 112 are set up with local models that are respectively suitable for processing the unlabeled data stored at each of them; and (ii) server subsystem 102 is set up with server model 302. The local models are sometimes referred to as client-side ML models. The server model is sometimes referred to as a server-side ML model. At this early point in the method of flowchart 250, both the local models and the server models are untrained.

Processing proceeds to operation S260, where the local models are each trained respectively on the unlabeled data of the client subsystem upon which the local model is hosted. This training result produces a collection of local representations at each client subsystem 104, 106, 108, 110, 112. In this embodiment, each representation is expressed in the form of a vector that captures useful inherent characteristics of the local unlabeled data.

Processing proceeds to operation S265, where each client subsystem 104, 106, 108, 110 and 112 sends its collection of local representations to input module (“mod”) 304 of server subsystem 102 through network 114.

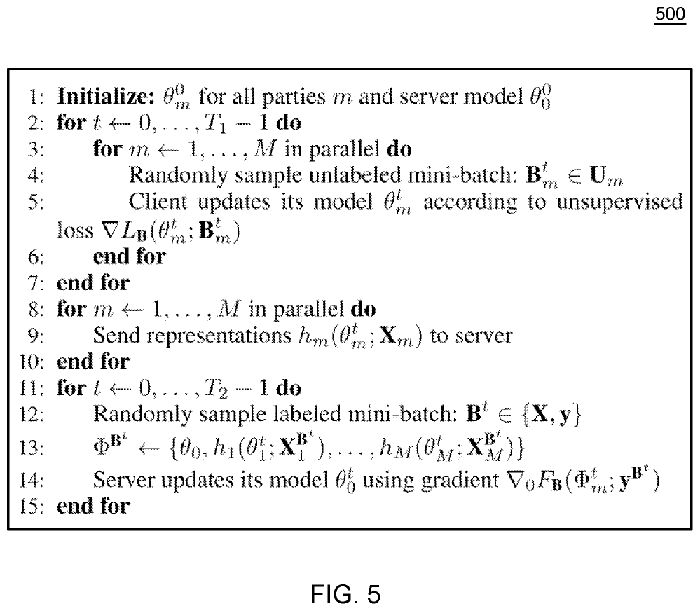

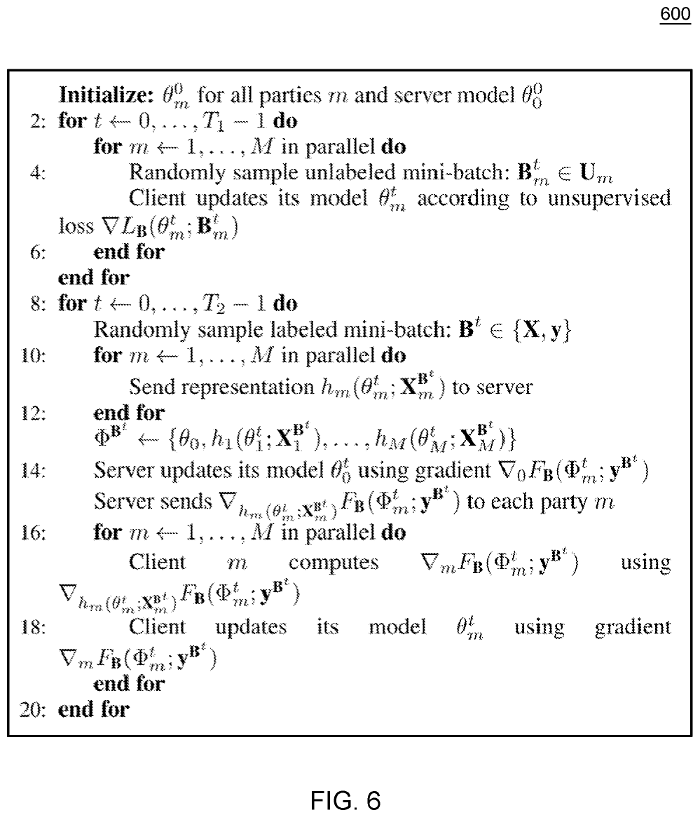

Processing proceeds to operation S270, where processing mod 306 aggregates the representations of the collections of local representations respectively received from each client subsystem 104, 106, 108, 110, 112. As will be seen in the next operation, these collections of local representations will be utilized as an input to train server model 302. In this embodiment, the collections of representations (in the form of vectors) are aggregated by being concatenated by mod 306 for further processing. An example of pseudocode for performing aggregation by concatenation is shown at: (i) line 1 of the algorithm of screenshot 500 of FIG. 5; and, also, (ii) at line 13 of the algorithm of screenshot 600 of FIG. 6.

Processing proceeds to operation S275, where processing mod 306 inputs the input obtained at the previous operation to server model 302 to train the server model using supervised learning. The trained version of the server model is sometimes herein referred to as a trained server-side ML model. The trained server model can recognize various patterns when it receives new representations from the plurality of client subsystems, as will be discussed below in connection with the next operation.

Processing proceeds to operation S280, where the trained version of the server mod makes a new prediction using new data. Operation S280 includes the following sub-operations: (i) each client subsystem 104, 106, 108, 110, 112 receives new unlabeled data for analysis; (ii) the new data is inputted into the local trained model of each client subsystem 104, 106, 108, 110, 112 to obtain a collection of new local representations; (iii) each client subsystem 104, 106, 108, 110, 112 sends its the collection of new local representations to input mod 304 of server subsystem 102; (iv) processing mod 306 aggregates the new local representations to obtain a new input to the trained version of server model 302; and (v) server model 302 makes a first prediction based on the new input. Output mod 308 sends out this prediction to interested parties.

### III. Further Comments and/or Embodiments

Some embodiments of the present invention recognize one, or more, of the following facts, potential problems and/or potential areas for improvement with respect to the current state of the art: (i) Unsupervised Representation Learning (URL) is a method of pre-training on unlabeled data to assist with Supervised Learning; (ii) first in the URL process is creating several augmentations of the unlabeled data; (iii) these augmentations are specific to the dataset being used, and will ideally create data samples that are similar to the original sample (for example, an image can be augmented by cropping, panning, adding noise, etc.); (iv) URL typically will train a representation model on unlabeled data and its augmentations to create low-dimensional representations; (v) the goal is for representations of augmentations from the same data sample to be “close” in the resulting representation space; (vi) the representation network is then frozen and used to pre-process labeled data; (vii) the labeled data representations are then used in Supervised Learning to train a final prediction model; (viii) it has been shown in centralized cases that URL pre-training can improve the generalization of the final prediction model; (ix) with respect to the potential application of URL to VFL, it is noted that clients only store a subset of features, making it unclear if local unsupervised training would be beneficial; (x) current VFL approaches rely on labeled data, and thus do not utilize the large amount of unlabeled data; (xi) this can lead to models being unable to generalize well to new sets of data; and/or (xii) labeling data is expensive and time consuming.

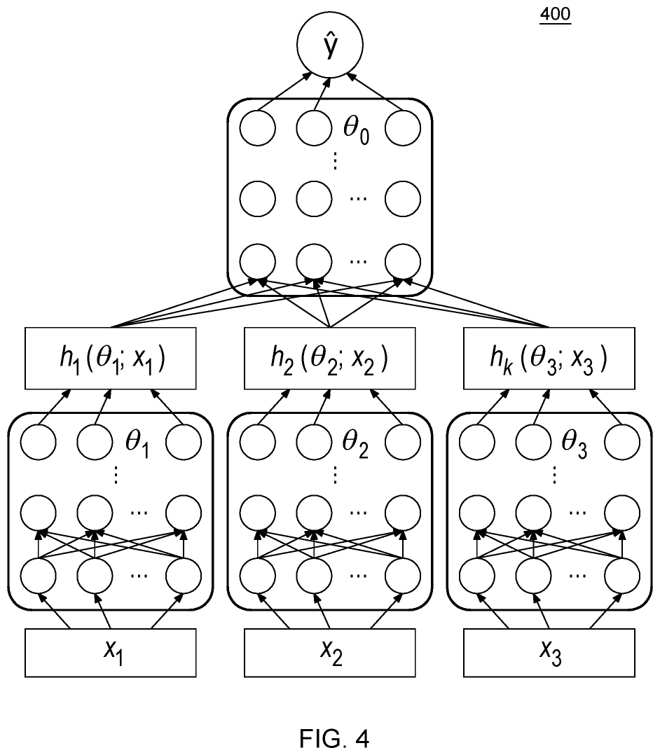

As shown in FIG. 4, block diagram 400 shows an example of a VFL model architecture. As shown in block diagram 400, features are vertically partitioned among a set of clients. A small fraction of the data is labeled, and the server stores the labels. Client features are private and cannot be shared. Clients each hold a local representation model that maps their local features to representations. The server holds a prediction model that takes the concatenation of client representations as input. Some embodiments of the present invention involve the design of a VFL approach where clients utilize local unlabeled data to improve training on labeled data with the server.

Code of screenshot 500 of FIG. 5 shows an embodiment of algorithm to utilize unlabeled data in a VFL setting. This algorithm potentially reduces communication cost in the following way: (i) clients pre-train a representation network locally on unlabeled data using their local feature sets; (ii) the resulting representations are sent to the server; and (iii) the server trains a prediction model locally on the representations for a supervised learning task. The algorithm of screenshot 500 utilizes URL to avoid needing several rounds of communication with the server. In the algorithm of screenshot 500: (i) each client creates augmentations of its local data; (ii) each client then trains a local representation model on its local features; (iii) after unsupervised training is complete, labeled data is fed through the representation model; (iv) the resulting representations are sent to the server; and (v) the server then trains the prediction model on the labeled representations. This algorithm potentially greatly reduces the communication cost of training over the standard VFL approach described, above, in the Background section.

Code of screenshot 600 of FIG. 6 shows an embodiment of algorithm that potentially improves generalization of a purely supervised task. Clients pre-train locally in an unsupervised manner as in the algorithm discussed in the previous paragraph. In the algorithm of screenshot 600, the representation networks are not frozen. The server and clients perform training together, updating both the prediction model and representation networks in a supervised manner. The algorithm of screenshot 600 utilizes URL to improve generalization of the final VFL model. In the algorithm of screenshot 600: (i) each client trains its representation model as in the algorithm discussed in the previous paragraph; (ii) the server and clients then collaboratively train on the labeled data, following the same process as in the standard VFL approach; (iii) this algorithm is similar to standard VFL approaches, with the added step of pre-training on unlabeled data; and (iv) it adds no additional communication cost to the training process.

Some embodiments of the present invention may include one, or more, of the following operations, features, characteristics and/or advantages: (i) trains local representation models on unlabeled vertically-partitioned data without the need for communication, then proceeds with downstream supervised training on labeled data; (ii) utilizes unlabeled vertically-partitioned data, without significant communication overhead; (iii) saves on communication by only sharing labeled representations, and keeps unlabeled data local to parties throughout training; (iv) trains several representation networks on unlabeled vertically-partitioned data; (v) shares only representations, outputs of a local model, rather than sharing neural networks; (v) utilizes unlabeled data to improve generalization and/or to avoid sample bias; (vi) shares only representations rather than large sets of model parameters; (vii) shares only representations, which are outputs of a local model; and/or (viii) because the amount of unlabeled data is typically much larger than that of labeled data, some embodiments of the present invention can greatly save on communication cost over conventional methods.

Vertical Federated Learning (VFL) is a distributed machine learning scenario where participants store private data that share a sample ID space, but a different sets of features. For example, a hospital, bank, and insurance company may want to jointly predict risk scores for individuals without directly sharing sensitive private data on the individuals. In this example, information on each individual is partitioned by their features across each institution. A standard VFL method typically includes several parties that hold local features and a label holder. Each party trains a local representation network, while the label holder trains a fusion network that combines the outputs of each representation network.

Contrastive Unsupervised Representation Learning (CURL) is a method of unsupervised training that creates compact representations of raw data, assisting in downstream supervised training. CURL excels at training representation networks without the need for labels, and CURL reduces the dimensionality of raw data, making representations relatively inexpensive to communicate to the label holder. As discussed below, some embodiments of the present invention are directed to two algorithms that naturally generalize CURL for VFL settings. More specifically, two Self-Supervised VFL algorithms (herein sometimes referred to as SS-VFL-I and SS-VFL-II) start by pre-training each participant's local representation network on unlabeled data using CURL. Note that the parties do not require any communication during this pre-training step. After pre-training is done, each algorithm utilizes a different method for downstream training.

An example of an SS-VFL-I type algorithm is shown in the code of screenshot 500 of FIG. 5. An example of an SS-VFL-II type algorithm is shown in the code of screenshot 600 of FIG. 6.

SS-VFL-I is a generalization of centralized CURL. Once pre-training is done, each party computes their representations for all available labeled data. These representations are then sent to the label holder. The label holder then trains its fusion network using the frozen representations. SS-VFL-I provides several benefits over standard VFL. Communication is immensely reduced, as representations for the labeled data must only be communicated once during training. Additionally, labels are inherently kept private, as the label holder need not share any gradient information with other parties. A potential challenge associated with this algorithm is that representations are frozen during downstream training, meaning information provided by labels cannot be used to update the representations, which can potentially limit performance.

SS-VFL-II is an alternative option that can potentially provide better downstream performance than SS-VFL-I. Unlike SS-VFL-I, SS-VFL-II updates representation networks during supervised training. After unsupervised pretraining, labeled data is fed through representation networks, the outputs are sent to the label holder, the label holder computes the loss and sends gradient information to parties to update their representation networks. SS-VFL-II is well-suited for VFL scenarios where label-privacy mechanisms have already been set in place. SS-VFL-II creates richer representations that are based on both unlabeled and labeled data, improving generalization over conventional VFL algorithms with no additional communication cost.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

And/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Set of thing(s): does not include the null set; “set of thing(s)” means that there exist at least one of the thing, and possibly more; for example, a set of computer(s) means at least one computer and possibly more.

What is claimed is:

1. A computer-implemented method (CIM) for use with a federated computer system that includes a server subsystem and a plurality of client subsystems, with each client sub-system including stored unlabeled data, with the server subsystem being in communication with each client subsystem through a communication network, and with each client subsystem not being permitted access to stored unlabeled data of other client subsystems of the federated computer system, the CIM comprising:
receiving, by the server subsystem, an untrained server-side machine learning (ML) model;
receiving, from each given client subsystem, over the communication network and by the server subsystem, a respective collection of representations that have been obtained at the given client subsystem through models located at the given client subsystem and trained on the unlabeled data of the given client subsystem using unsupervised learning;
aggregating, by the server subsystem, the representations of the collections of representations respectively received from each client subsystem of the plurality of client subsystems to obtain an input to the untrained server-side machine learning (ML) model; and
inputting the input to the untrained server-side ML model to train the untrained server-side ML model using supervised learning to thereby obtain a trained server-side ML model that can recognize a plurality of patterns when the trained server-side ML model receives new representations from the plurality of client subsystems.

2. The CIM of claim 1 further comprising:
receiving, by each client subsystem of the plurality of client subsystems, new data for analysis;
inputting the new data to a respective trained ML model of each client subsystem of the plurality of client subsystems, to obtain a collection of new representations;
sending, by each client subsystem, through the communication network and to the server subsystem, the collection of new representations;
aggregating, by the server subsystem, the representations of the collections of new representations to obtain a new input to the trained server-side ML model; and
using the trained server-side ML model to make a first prediction based on the new input.

3. The CIM of claim 1 wherein:
the collections of representations obtained at the given client subsystem are in the form of vectors; and
the unlabeled data of the client subsystems cannot be derived from the vectors.

4. The CIM of claim 1 wherein the aggregation of the representations includes concatenation of the collections of representations received from the plurality of client subsystems.

5. The CIM of claim 1 further comprising:
sending feedback data from the server subsystem to a first client subsystem of the plurality of client subsystems; and
providing further training to the model located at the first client subsystem based on the feedback data.

6. The CIM of claim 1 wherein the training of the untrained server-side ML model includes supervised learning.

7. A computer program product (CPP) for use with a federated computer system that includes a server subsystem and a plurality of client subsystems, with each client sub-system including stored unlabeled data, with the server subsystem being in communication with each client subsystem through a communication network, and with each client subsystem not being permitted access to stored unlabeled data of other client subsystems of the federated computer system, the CPP comprising:
a set of storage device(s); and
computer code stored collectively in the set of storage device(s), with the computer code including data and instructions to cause a processor(s) set to perform at least the following operations:
receiving, by the server subsystem, an untrained server-side machine learning (ML) model,
receiving, from each given client subsystem, over the communication network and by the server subsystem, a respective collection of representations that have been obtained at the given client subsystem through models located at the given client subsystem and trained on the unlabeled data of the given client subsystem using unsupervised learning,
aggregating, by the server subsystem, the representations of the collections of representations respectively received from each client subsystem of the plurality of client subsystems to obtain an input to the untrained server-side machine learning (ML) model, and
inputting the input to the untrained server-side ML model to train the untrained server-side ML model using supervised learning to thereby obtain a trained server-side ML model that can recognize a plurality of patterns when the trained server-side ML model receives new representations from the plurality of client subsystems.

8. The CPP of claim 7 wherein the computer code further includes instructions for causing the processor(s) set to perform the following operation(s):
receiving, by each client subsystem of the plurality of client subsystems, new data for analysis;
inputting the new data to a respective trained ML model of each client subsystem of the plurality of client subsystems, to obtain a collection of new representations; sending, by each client subsystem, through the communication network and to the server subsystem, the collection of new representations;
aggregating, by the server subsystem, the representations of the collections of new representations to obtain a new input to the trained server-side ML model; and
using the trained server-side ML model to make a first prediction based on the new input.

9. The CPP of claim 7 wherein:
the collections of representations obtained at the given client subsystem are in the form of vectors; and
the unlabeled data of the client subsystems cannot be derived from the vectors.

10. The CPP of claim 7 wherein the aggregation of the representations includes concatenation of the collections of representations received from the plurality of client subsystems.

11. The CPP of claim 7 wherein the computer code further includes instructions for causing the processor(s) set to perform the following operation(s):
sending feedback data from the server subsystem to a first client subsystem of the plurality of client subsystems; and
providing further training to the model located at the first client subsystem based on the feedback data.

12. The CPP of claim 7 wherein the training of the untrained server-side ML model includes supervised learning.

13. A computer system (CS) for use with a federated computer system that includes a server subsystem and a plurality of client subsystems, with each client sub-system including stored unlabeled data, with the server subsystem being in communication with each client subsystem through a communication network, and with each client subsystem not being permitted access to stored unlabeled data of other client subsystems of the federated computer system, the CS comprising:
a processor(s) set;
a set of storage device(s); and
computer code stored collectively in the set of storage device(s), with the computer code including data and instructions to cause the processor(s) set to perform at least the following operations:
receiving, by the server subsystem, an untrained server-side machine learning (ML) model,
receiving, from each given client subsystem, over the communication network and by the server subsystem, a respective collection of representations that have been obtained at the given client subsystem through models located at the given client subsystem and trained on the unlabeled data of the given client subsystem using unsupervised learning,
aggregating, by the server subsystem, the representations of the collections of representations respectively received from each client subsystem of the plurality of client subsystems to obtain an input to the untrained server-side machine learning (ML) model, and
inputting the input to the untrained server-side ML model to train the untrained server-side ML model using supervised learning to thereby obtain a trained server-side ML model that can recognize a plurality of patterns when the trained server-side ML model receives new representations from the plurality of client subsystems.

14. The CS of claim 13 wherein the computer code further includes instructions for causing the processor(s) set to perform the following operation(s):
receiving, by each client subsystem of the plurality of client subsystems, new data for analysis;
inputting the new data to a respective trained ML model of each client subsystem of the plurality of client subsystems, to obtain a collection of new representations;
sending, by each client subsystem, through the communication network and to the server subsystem, the collection of new representations;
aggregating, by the server subsystem, the representations of the collections of new representations to obtain a new input to the trained server-side ML model; and
using the trained server-side ML model to make a first prediction based on the new input.

15. The CS of claim 13 wherein:
the collections of representations obtained at the given client subsystem are in the form of vectors; and
the unlabeled data of the client subsystems cannot be derived from the vectors.

16. The CS of claim 13 wherein the aggregation of the representations includes concatenation of the collections of representations received from the plurality of client subsystems.

17. The CS of claim 13 wherein the computer code further includes instructions for causing the processor(s) set to perform the following operation(s):
sending feedback data from the server subsystem to a first client subsystem of the plurality of client subsystems; and
providing further training to the model located at the first client subsystem based on the feedback data.

18. The CS of claim 13 wherein the training of the untrained server-side ML model includes supervised learning.
